(19) United States
(12) Patent Application Publication
(10) Pub. No.: US 2025/0008278 A1
(43) Pub. Date: Jan. 2, 2025

(54) A NON-SURGICAL HEARING SYSTEM AND METHOD THEREOF

(71) Applicants: R. RAMAN, Madurai (IN); R. LAKSHMANAN, Madurai (IN)

(72) Inventors: R. RAMAN, Madurai (IN); R. LAKSHMANAN, Madurai (IN)

(21) Appl. No.: 18/703,204

(22) PCT Filed: Apr. 14, 2024
(86) PCT No.: PCT/IN2022/050358

§ 371 Date: Apr. 19, 2024

(30) Foreign Application Priority Data
Oct. 20, 2021 (IN) 202141047709

(51) Int. Cl. H04R 25/00; H04R 1/10

(52) U.S. Cl. CPC H04R 25/606; H04R 1/1041; H04R 1/105; H04R 25/50; H04R 25/554; H04R 25/607; H04R 2225/0213; H04R 2225/61; H04R 2460/13

(57) ABSTRACT

The present invention discloses a non-surgical bone conduction hearing system (100) and method which can be used either as a hearing aid for hearing loss users as well as an audio device for normal people. The hearing system (100) comprises a hearing device (102) and an adhesive member (106). Further, the hearing device (102) comprises a female mating member (104) and the adhesive member (106) comprises a male mating member (108). The adhesive member (106) may comprise an adhesive surface on other side which is attached behind the ear of the user. The female mating member (104) of the hearing device (102) is connected to the male mating member (108) of the adhesive member (106). Thus, using the hearing system (100), the audio signals are processed and transmitted through vibrations into the hearing organ via bone conduction.

### FIELD OF INVENTION

The field of invention generally relates to hearing devices. More specifically, it relates to a non-surgical hearing system and method that can be used either as a hearing aid or a hearing device and transmits acoustic signals to the hearing organ through bone conduction.

### BACKGROUND

Bone conduction hearing aids commonly known as bone conduction devices mechanically transmit sound information to a recipient's cochlea by transferring vibrations to a person's skull. The bone conduction devices transfer vibrations from an external vibrator to the skull through a bone conduction implant. The bone conduction implant penetrates the skin and is physically attached to both the vibrator and the skull.

The traditional bone conductor hearing aid comprises a vibrator that is pressed against the head behind the ear by a spring arrangement extending from the other side of the head. The constant pressure created by the spring arrangement against the skull bone often causes headaches and skin irritation.

A direct bone conductor comprises a vibrator, which is directly and firmly connected to an anchoring component. The anchoring component is anchored to the skull bone through which the vibrations are directly transmitted from the vibrator to the skull bone. This type of bone conductor may be designed with a permanent skin penetration which may lead to problems with skin infections.

In general, earphones are composed of earphone terminals, an earphone cable, and a plug. The earphone terminals are directly inserted into the ear to hear the music and audio through the earphone cable. However, listening audio or music for a long time through the earphone may damage the inner ear organ resulting in a hearing loss.

Thus, in light of the above discussion, it is implied that there is a need for a hearing system and method which is non-surgical, bone conductor, can be used as a normal hearing device and does not suffer from the problems discussed above.

### OBJECT OF INVENTION

The principle object of this invention is to provide a hearing system and method which is non-surgical and bone conduction hearing device.

The other object of the invention is to provide a hearing system, which can be used as a hearing aid for users with sensorineural, conductive, mixed and single sided hearing losses.

The other object of the invention is to provide a dual use hearing system that can be used either as a hearing aid for hearing loss patients and as an audio device for normal people.

A further object of the invention is to provide a hearing system which can be attached behind the ear of the user.

Another object of the invention is to provide a bone conduction hearing system which sends sound vibrations directly to cochlea through auditory nerve.

### BRIEF DESCRIPTION OF FIGURES

This invention is illustrated in the accompanying drawings, throughout which, like reference letters indicate corresponding parts in the various figures.

The embodiments herein will be better understood from the following description with reference to the drawings, in which:

FIG. 1A depicts a perspective view of a non-surgical bone conduction hearing system, in accordance with an embodiment:

FIG. 1B depicts a side view of an assembled non-surgical bone conduction hearing system, in accordance with an embodiment:

FIG. 1C depicts a top view of a non-surgical bone conduction hearing system, in accordance with an embodiment:

FIG. 2A depicts attachment of the adhesive member behind the ear of the user, in accordance with an embodiment:

FIG. 2B depicts placement of the hearing device behind the ear of the user, in accordance with an embodiment:

FIG. 3A depicts an ear hook structure for attaching the hearing device, in accordance with an embodiment:

FIG. 3B depicts the ear hook structure supported by the ear of the user, in accordance with an embodiment;

FIG. 4A depicts an alternate design of the ear hook structure with dual hooks, in accordance with an embodiment;

FIG. 4B depicts the alternative design of the ear hook structure assembled with the hearing device, in accordance with an embodiment;

FIG. 4C depicts rear part of the assembled ear hook structure, in accordance with an embodiment;

FIG. 4D depicts the assembled ear hook structure placed behind the user ear, in accordance with an embodiment;

FIG. 5 depicts a head band design for attaching the hearing device, in accordance with an embodiment;

FIG. 6 depicts a ring featured structure for attaching the hearing device, in accordance with an embodiment;

FIG. 7 depicts an assembled ring featured structure connected to the head band, in accordance with an embodiment;

FIG. 8A depicts an assembly of the adhesive member and the head band on the user head, in accordance with an embodiment;

FIG. 8B depicts an assembly of an assembled ring featured structure connected to the head band, in accordance with an embodiment;

FIG. 9 depicts a block diagram representation of components enclosed in the hearing device.

FIG. 10 depicts a method of using the hearing system, in accordance with an embodiment.

### DETAILED DESCRIPTION

The embodiments herein and the various features and advantageous details thereof are explained more fully with reference to the non-limiting embodiments that are illustrated in the accompanying drawings and/or detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

The present invention discloses a system and method for a bone conduction hearing which provides a hearing device attached behind the ear of the user. The hearing device transmits audio signals into the hearing organ through bone conduction, where the acoustic signals are converted into sound vibrations and conducted through skull bone. The proposed hearing system facilitates the hearing loss users and the normal users to use the hearing device as a hearing aid and as an ear phone.

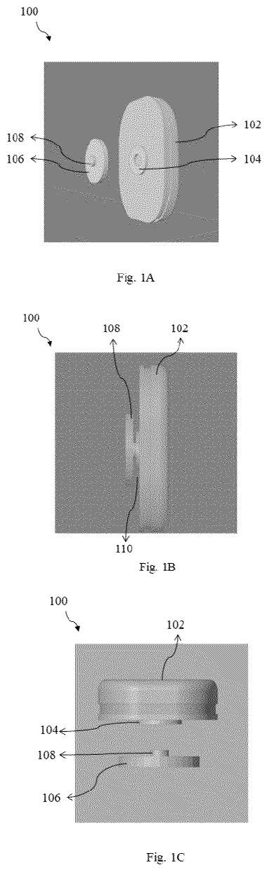

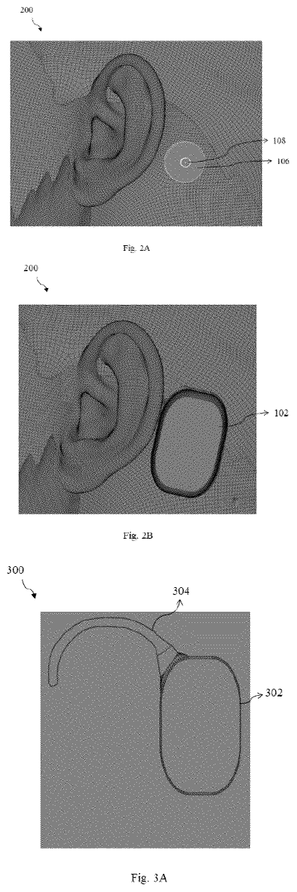

FIG. 1A depicts a perspective view of a non-surgical bone conduction hearing system 100 comprising a hearing device 102 and an adhesive member 106 with corresponding mating members.

In an embodiment, the hearing device 102 comprises a female mating member 104 and the adhesive member 106 comprises a male mating member 108.

In an embodiment, back part of the adhesive member 106 is attached behind the ear of the user and front part of the adhesive member 106 is formed with the male mating member 108. The hearing device 102 is fitted on the adhesive member 106 by connecting the female mating member 104 with the male mating member 108.

In an embodiment, the adhesive member 106 may comprise an adhesive patch or sheet where one side of the adhesive patch may comprise the male mating member 108 to connect to the female mating member 104 of the hearing device 102. The other side of the adhesive patch may comprise an adhesive surface which is removably attached to the skin on the head behind the ear of the user.

In an embodiment, the adhesive patch may comprise holes to overcome issues due to sweating at the attached skin area.

In an embodiment, the female mating member 104 and the male mating member 108 may comprise at least one of silicon, plastic and magnetic mating member, among others. Alternatively, the female mating member 104 and the male mating member 108 may comprise various other soft mating attachments that do not cause any skin issues or problems to the user.

The hearing device 102 is configured with an enclosure which encloses various components of the hearing device 102. The components of the hearing device 102 may convert and transmit the audio signals into inner ear of the user through bone conduction.

FIG. 1B depicts a side view of an assembled non-surgical bone conduction hearing system 100. The male mating member 108 is inserted into the female mating member 104 forming an assembled connection 110.

FIG. 1C depicts a top view of a non-surgical bone conduction hearing system 100.

FIG. 2A depicts attachment of the adhesive member behind the ear of the user 200. The adhesive member 102 is attached behind the ear.

FIG. 2B depicts placement of the hearing device behind the ear of the user 200. The hearing device 102 is placed on the adhesive member 106 which is attached behind the ear of the user. The hearing device 102 is connected to the adhesive member 106 by connecting the male mating member 108 and the female mating member 104.

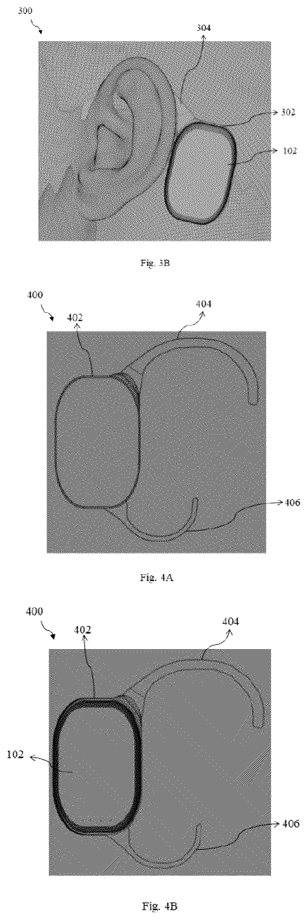

FIG. 3A depicts an ear hook structure 300 for attaching the hearing device.

In an embodiment, the ear hook structure 300 comprises a device enclosing part 302 and a hook part 304. The device enclosing part 302 is designed to enclose the hearing device 102.

FIG. 3B depicts the ear hook structure 300 supported by the ear of the user.

In an embodiment, the hearing device 102 is enclosed in the device enclosing part 302 and the assembled ear hook structure is placed behind the ear of the user. Further, the hearing device 102 is connected to the adhesive member 106 and the hook part 304 is anchored to the user ear so that the ear hook structure is supported by the user ear firmly.

In an embodiment, the hook part 304 may be flexible and may be adjusted or bent while it is anchored on the user ear. The hook part 304 of the ear hook structure 300 may comprise a flexible outer component and an adjustable or bendable inner wire component.

In an embodiment, the ear hook structure 300 may be attached to at least one of non surgical bone conduction hearing device 102, any type of hearing aid, cochlear implant sound processor, behind the ear devices (BTE) and bone anchoring hearing implants processor (BAHA) among others.

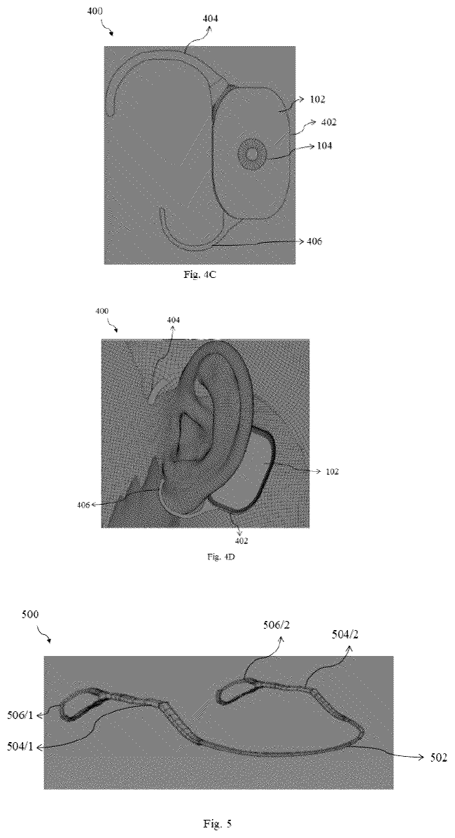

FIG. 4a depicts an alternate design of the ear hook structure 400 with dual hooks.

In an embodiment, the ear hook structure 400 comprises a device enclosing part 402, a primary hook part 404 and a secondary hook part 406. The device enclosing part 402 is designed to enclose the hearing device 102. The primary hook part 404 is designed to anchor to the upper part of the user ear and the secondary hook part 406 is designed to anchor to the lower part of the user ear.

In an embodiment, the hearing device 102 enclosure may be designed with an outer groove part formed around the peripheral of the hearing device 102 that facilitates the hearing device 102 to easily fit into the devices enclosing part 302. The device enclosing part 302 thereby sits into the outer groove part and firmly grips the hearing device 102.

FIG. 4B depicts the alternative design of ear hook structure 400 assembled with the hearing device.

FIG. 4C depicts rear part of the assembled ear hook structure 400. The rear part of the ear hook structure 400 after assembling with the hearing device 102 is depicted, where the female mating member 104 of the hearing device 102 is depicted.

FIG. 4D depicts the assembled ear hook structure 400 placed behind the user ear.

In an embodiment, the ear hook structure 400 with dual hooks is assembled with the hearing device 102 and placed behind the ear of the user. The hearing device 102 is connected to the adhesive member 106 which is attached behind the ear. The primary hook part 404 is anchored to the upper part of the user ear and the secondary hook part 406 is anchored to the lower part of the user ear. The primary hook part 404 and the secondary hook part 406 firmly support the hearing device 102 by the user ear.

In an embodiment, the device enclosing parts 302 and 402 of the ear hook structures 300 and 400 may be designed with a rigid material to firmly secure the hearing device 102 within it.

FIG. 5 depicts a head band 500 design for attaching the hearing device.

In an embodiment, the head band 500 comprises an elongated band support 502 that surrounds and covers the behind part of the head when worn by the user.

The head band 500 further comprises a pair of device supporting sections 504/1 and 504/2 which are thicker when compared to the elongated band support 502 and firmly support hearing devices 102 on either of the head band 500. The pair of device supporting sections 504/1 and 504/2 are designed to be place behind the ear when worn by the user, so that the hearing devices 102 may be placed behind the ear of the user.

The head band 500 further comprises a pair of end sections 506/1 and 506/2 which are designed to sit in front of the ears when worn by the user so that the head band 500 is supported by the pair of end sections 506/1 and 506/2.

In an embodiment, the head band 500 may be flexible and adjustable so that the user may adjust the head band 500 to securely fit to the user's head. In an embodiment, the pair of device supporting sections 504/1 and 504/2 may be designed with rigid material compared to other sections of the head band 500, so that the device supporting sections 504/1 and 504/2 may firmly hold the hearing device 102.

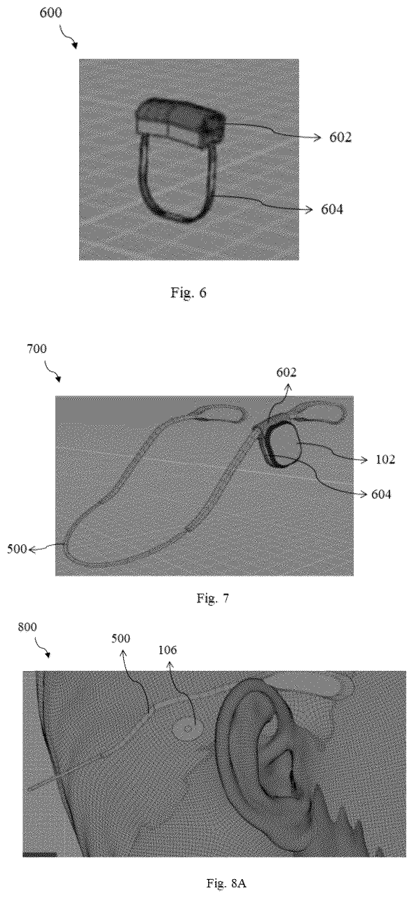

FIG. 6 depicts a ring featured structure 600 for attaching the hearing device.

In an embodiment, the ring featured structure 600 comprises a band connector 602 and a device holder 604. The band connector 602 is designed to connect to the device supporting section 504 of the head band 500. The device holder 604 is designed to accommodate the hearing device 102.

In an embodiment, the band connector 602 may comprise adjustable connecting parts to facilitate easy and secure connection of the ring featured structure 600 to the head band 500. In an embodiment, the band connector 602 may comprise either a clip mechanism or a lock mechanism or a Velcro strap mechanism.

In an embodiment, the device holder 604 may be designed with a rigid material to firmly secure the hearing device 102 within it.

FIG. 7 depicts an assembled ring featured structure 700 connected to the head band.

In an embodiment, the hearing device 102 is assembled into the device holder 604 and the band connector 602 is fixed to the head band 500.

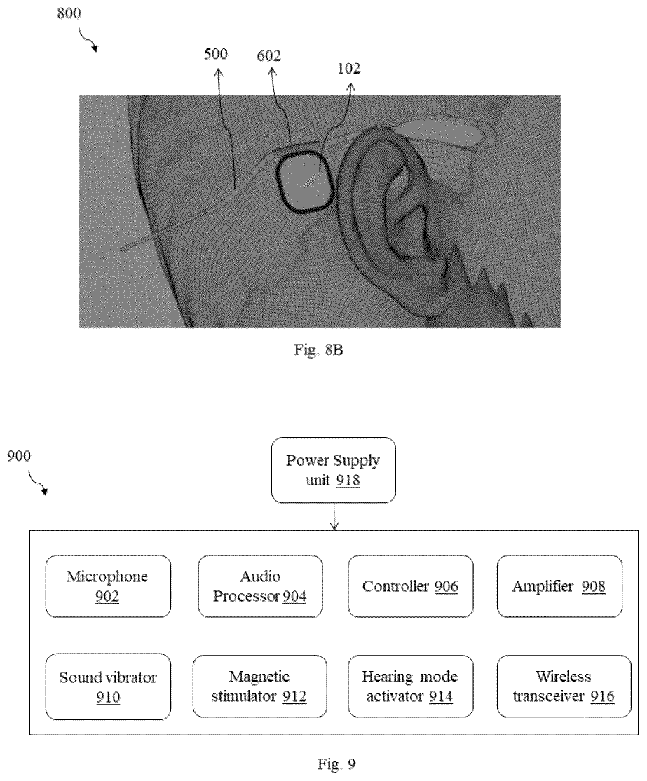

FIG. 8A depicts an assembly 800 of the adhesive member and the head band on the user head. In an embodiment, the adhesive member 106 is attached behind the ear and the head band 500 is worn from behind the head by the user.

FIG. 8B depicts an assembly 800 of an assembled ring featured structure connected to the head band.

In an embodiment, once the assembled ring featured structure 600 is fixed to the head band 500, the head band 500 is worn by the user head from behind the head. The hearing device 102 is placed behind the ear so that the female mating member 104 of the hearing device 102 is connected with the male mating member 108 of the adhesive member 106 which is attached behind the ear.

In an embodiment, the ring featured structure 600 may be assembled with the hearing device 102 and fixed to end terminals of spectacles. Consequently, when the spectacles are worn by the user, the end terminals may reach behind the ear of the user and so the hearing device 102 may be attached to the adhesive member 106.

In an embodiment, the hearing device 102 may be incorporated with a button or switch to facilitate the user to change the hearing mode of the hearing device 102 between a hearing aid mode and a regular mode. The hearing aid mode is arranged for hearing aid users who may have sensorineural, conductive, mixed and single sided hearing losses In the hearing aid mode, the hearing device 102 is used as a hearing aid device. The regular mode is arranged for normal users so that the hearing device 102 is used as an ear phone to listen to audio or music.

In an embodiment, the hearing device 102 may enclose a mode changing component to change the hearing mode when the user presses the button. In an embodiment, in the hearing aid mode, the components enclosed in the hearing device 102 may receive audio signals from surrounding environment.

In the regular mode, the components enclosed in the hearing device 102 may receive audio signals from an external device. The external device may comprise a smart device such as a portable computing device, a smart mobile phone, a tablet PC, or any other appropriate storage and/or communication device that may be connected to the hearing device 102 either through wired or wireless.

In an embodiment the hearing device 102 may comprise a connection slot to connect the wired plug of the external device.

FIG. 9 depicts a block diagram representation of components 900 enclosed in the hearing device.

In an embodiment, the components 900 of the hearing device 102 may comprise a microphone 902, an audio processor 904, a controller 906, an amplifier 908, a sound vibrator 910, a magnetic stimulator 912, a hearing mode activator 914, a wireless transceiver 916 and a power supply unit 918.

The microphone 902 is configured to capture audio signals from ambient sounds or from voices from one or more persons around the user and transmit the audio signals to the audio processor 904. In an embodiment, the microphone 902 may comprise, but not limited to, analog, digital, MEMS, electret, active, passive, directional or omni-directional or a combination thereof.

The audio processor 904 processes the audio signals and transmits the processed audio signals to the controller 906. The controller 906 transmits electrical signals to an amplifier 908.

The amplifier 908 amplifies the electrical signals and transmits the amplified signals to the sound vibrator 910. The sound vibrator 910 converts the amplified signals into vibrations which are transmitted to the inner ear via bone conduction.

In an embodiment, the sound vibrator 910 may comprise at least one of a DC vibrational motor, a coreless DC vibration motor, an electromagnetic vibrator or a bone conduction vibrator.

In an embodiment, a magnetic stimulator 912 may comprise a pair of resonant coils have magnetic cores around which the current carrying wires are wound. The modulated electrical signals from the controller 906 generate a stimulatory electromagnetic field to selectively activate sensory neurons in the user brain, thus to provide a sensory audible stimulation. The magnetic stimulation may be provided either using a transcranial magnetic stimulation coil or a DC motor.

In an embodiment, a hearing mode activator 914 may work in conjunction with a button provided on the hearing device 102. The hearing mode activator 914 is configured to change the hearing mode of the hearing device 102. The hearing mode may comprise a hearing aid mode and a regular mode. The hearing aid mode is configured for hearing loss users and the regular mode is configured for normal users to avoid hearing loss.

When the user presses the button for a hearing aid mode, the hearing mode activator 914 sends signal to the controller 906 and the controller 906 activates the microphone 902 to capture ambient audio signals. When the user presses the button for a regular mode, the hearing mode activator 914 sends signal to the controller 906 and the controller 906 activates the wireless transceiver 916 to receive audio or music from an external device of the user. The audio signal is processed by the audio processor 904. Thus, in the regular mode, the hearing device 102 may be used as a wireless audio device such as an earphone.

Alternatively, in an embodiment, the hearing device 102 may comprise a slot to allow insertion of wired plug of the external device, thus allowing the hearing device 102 for wired connections in regular mode.

In an embodiment, the wireless transceiver 916 may comprise a Bluetooth communication to connect the hearing device 102 the user's device such as a smart phone in regular mode. In an embodiment, the Bluetooth communication further enable application integration, customization of hearing device, speech therapy, and live listening.

In an embodiment, the button provided on the hearing device 102 to activate the hearing mode activator 914 may comprise either a toggle button or a haptic button or a tactile button or a touch button

In an embodiment, the hearing mode may be activated by smart device like smartphone with Bluetooth connectivity.

In an embodiment, a power supply unit 918 may comprise a battery for supplying power to the components of the hearing device 102.

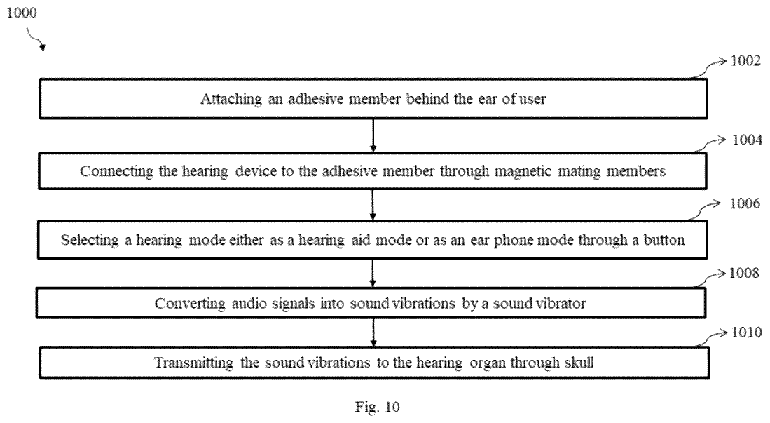

FIG. 10 depicts a method 1000 of using the hearing system.

In an embodiment, the method 1000 begins with attaching an adhesive member behind the ear of the user, as depicted at step 1002. Subsequently, the hearing device is connected to the adhesive member through corresponding mating members which may comprise at least one of silicon, plastic, and magnetic mating members, among others, as depicted at step 1004. Thereafter, the hearing mode of the hearing device is selected by the user either as a hearing aid mode or as an ear phone mode through a button provided on the hearing device, as depicted at step 1006.

Later, the audio input signals are converted into sound vibrations by the sound vibrator, as depicted at step 1008. Next, the sound vibrations are transmitted to the hearing organ i.e., inner ear through skull, as depicted at step 1010.

The hearing system provides a non-surgical and bone conduction hearing device that transmits the sound vibrations from the sound vibrator to the cochlea through the auditory nerve. The hearing system may be used as a hearing aid for users with sensorineural, conductive, mixed and single sided hearing losses. The hearing system not only facilitates users with hearing loss, but also avoids hearing loss for normal people.

The hearing system may be utilized as a hearing aid and as an audio device such as ear phone, since the audio signals are transmitted through skull via vibrations.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the scope of the embodiments as described here.

We claim:

1. A non-surgical hearing system (100) configured as a hearing aid, comprising:
a hearing device (102) for converting and transmitting audio signals to a user through bone conduction, wherein the hearing device (102) comprises a female mating member (104); and
an adhesive member (108) to be attached to the user, wherein the adhesive member (108) comprises a male mating member (108) configured to be attached to the female mating member (104) of the hearing device (102).

2. The non-surgical hearing system (100) as claimed in claim 1, comprising an ear hook structure (300) for supporting the hearing device (102) attachment to the user, wherein the ear hook structure (300) comprises:
a device enclosing part (302) configured to enclose the hearing device (102); and
a hook part (304) configured to anchor the hearing device (102) to the user's ear, wherein the hook part (304) comprises a flexible outer component and an adjustable or bendable inner wire component.

3. The non-surgical hearing system (100) as claimed in claim 2, wherein the ear hook structure (400) comprises dual hooks assembled with the hearing device (102) and placed behind the user's ear, and wherein the ear hook structure (400) comprises:
a device enclosing part (402) configured to enclose the hearing device (102);
a primary hook part (404) configured to anchor to an upper part of the user ear; and
a secondary hook part (406) configured to anchor to a lower part of the user ear.

4. The non-surgical hearing system (100) as claimed in claim 2, wherein the a hearing system (100) can be used as at least one of non surgical bone conduction hearing device (102), a hearing aid, cochlear implant sound processor, behind the ear devices (BTE) and bone anchoring hearing implants processor (BAHA).

5. The non-surgical hearing system (100) as claimed in claim 1, wherein the female mating member (104) and the male mating member (108) comprise at least one of silicon, plastic, and magnetic mating members.

6. The non-surgical hearing system (100) as claimed in claim 1, wherein a back part of the adhesive member (106) is removably attached to the user, and wherein a front part of the adhesive member (106) is attached to the male mating member (108).

7. The non-surgical hearing system (100) as claimed in claim 1, wherein the adhesive member (106) comprises an adhesive sheet or patch with holes, and wherein the female mating member (104) and the male mating member (108) comprise soft mating attachments for user comfort

8. The non-surgical hearing system (100) as claimed in claim 1, wherein the hearing device (102) comprises an enclosure, comprising:
a microphone (902) configured to capture ambient audio signals or voices and transmit the audio signals to an audio processor (904);
the audio processor (904) configured to process the audio signals and transmit the processed audio signals to a controller (906);
the controller (906) configured to transmit electrical signals to an amplifier (908);
the amplifier (908) configured to amplify the electrical signals and transmit the amplified signals to a sound vibrator (910);
the sound vibrator (910) configured to convert the amplified signals into vibrations transmitted to a user's inner ear via bone conduction;
a magnetic stimulator (912) configured to provide magnetic stimulation using a transcranial magnetic stimulation coil or a DC motor,
a hearing mode activator (914) configured to change the hearing mode of the hearing device (102) through a button provided on the hearing device (102);
a wireless transceiver (916) comprising bluetooth communication to connect the hearing device (102) to a user's device; and
an outer groove part formed around the peripheral of the hearing device (102) that enables the hearing device (102) to be fitted into the device enclosing part (302).

9. The non-surgical hearing system (100) as claimed in claim 8, wherein the magnetic stimulator (912) is configured to generate a stimulatory electromagnetic field from modulated electrical signals from the controller (906) to provide a sensory audible stimulation, and wherein the magnetic stimulator (912) comprises a pair of resonant coils comprising magnetic cores around which current carrying wires are wound.

10. The non-surgical hearing system (100) as claimed in claim 1, wherein the hearing device (102) comprises a head band (500) for attaching the hearing device (102), comprising:
an elongated band support (502) that surrounds and covers the behind part of the head when worn by the user;
a pair of device supporting sections (504/1) and (504/2) configured to be place behind the ear when worn by the user, so that the hearing device (102) can be placed behind the ear of the user and firmly supported on either of the head band (500); and
a pair of end sections (506/1) and (506/2) configured to sit in front of the ears when worn by the user to support the head band (500).

11. The non-surgical hearing system (100) as claimed in claim 10, wherein the hearing device (102) comprises a ring featured structure (600) comprising:
a band connector (602) configured to connect to a device supporting section (504) of the head band (500), wherein the band connector (602) comprises adjustable connecting parts to enable connection of the ring featured structure (600) to the head band (500); and
a device holder (604) comprising a rigid material to firmly secure the hearing device (102).

12. The non-surgical hearing system (100) as claimed in claim 10, wherein the head band (500) is connected to an assembly (800) of an assembled ring featured structure, configured to:
fix the assembled ring featured structure (600) to the head band (500); and
place the hearing device (102) behind the user's ear so that the female mating member (104) of the hearing device (102) is connected with the male mating member (108) of the adhesive member (106) which is attached behind the ear.

13. The non-surgical hearing system (100) as claimed in claim 1, wherein the hearing device (102) comprises a button or switch to enable the user to change between two hearing modes of the hearing device (102), wherein the two hearing modes comprises a hearing aid mode and a regular mode.

14. The non-surgical hearing system (100) as claimed in claim 13, wherein the hearing aid mode is configured to enable using the hearing device (102) as hearing aid device, comprises the microphone (902) captures ambient audio signals from a surrounding environment;

15. The non-surgical hearing system (100) as claimed in claim 13, wherein the regular mode configured to enable using the hearing device (102) as an ear phone comprises the wireless transceiver (916) and the audio processor (904) to receive audio signals from an external device connected to the hearing device (102).

16. A method for using non-surgical hearing system (100) comprising:
attaching an adhesive member (106) behind the ear of the user;
connecting a hearing device (102) to the adhesive member (106);
selecting the hearing mode of the hearing device (102) by the user either as a hearing aid mode or as an ear phone mode;
converting the audio input signals into sound vibrations; and
transmitting the sound vibrations to the hearing organ.

17. The method as claimed in claim 16, comprising:
attaching an adhesive member (106) behind the ear of the user;
connecting a hearing device (102) to the adhesive member (106) through corresponding magnetic mating members;
selecting the hearing mode of the hearing device (102) by the user either as a hearing aid mode or as an ear phone mode through a button provided on the hearing device (102);
converting the audio input signals into sound vibrations by the sound vibrator (910); and
transmitting the sound vibrations to the hearing organ through skull.

18. The method as claimed in claim 16, comprising an ear hook structure (300) for supporting the hearing device (102) attachment to the user, wherein the ear hook structure (300) comprises:
a device enclosing part (302) configured to enclose the hearing device (102); and
a hook part (304) configured to anchor the hearing device (102) to the user's ear, wherein the hook part (304) comprises a flexible outer component and an adjustable or bendable inner wire component.

19. The method as claimed in claim 16, wherein the ear hook structure (400) comprises dual hooks assembled with the hearing device (102) and placed behind the user's ear, and wherein the ear hook structure (400) comprises:
a device enclosing part (402) configured to enclose the hearing device (102);
a primary hook part (404) configured to anchor to an upper part of the user ear; and
a secondary hook part (406) configured to anchor to a lower part of the user ear.

20. The method as claimed in claim 16, wherein the ear hook structure (400) configured to hold any type of hearing wearable devices.

21. The method as claimed in claim 16, wherein the female mating member (104) and the male mating member (108) comprise at least one of silicon, plastic and magnetic mating members.

22. The method as claimed in claim 16, wherein a back part of the adhesive member (106) is removably attached to the user, and wherein a front part of the adhesive member (106) is attached to the male mating member (108).

23. The method as claimed in claim 16, wherein the adhesive member (106) comprises an adhesive sheet or patch with holes, and wherein the female mating member (104) and the male mating member (108) comprise soft mating attachments for user comfort.

24. The method as claimed in claim 16, wherein the hearing device (102) comprises an enclosure, comprising:
a microphone (902) configured to capture ambient audio signals or voices and transmit the audio signals to an audio processor (904);
the audio processor (904) configured to process the audio signals and transmit the processed audio signals to a controller (906);
the controller (906) configured to transmit electrical signals to an amplifier (908);
the amplifier (908) configured to amplify the electrical signals and transmit the amplified signals to a sound vibrator (910);
the sound vibrator (910) configured to convert the amplified signals into vibrations transmitted to a user's inner ear via bone conduction;
a magnetic stimulator (912) configured to provide magnetic stimulation using a transcranial magnetic stimulation coil or a DC motor,
a hearing mode activator (914) configured to change the hearing mode of the hearing device (102) through a button provided on the hearing device (102);
a wireless transceiver (916) comprising bluetooth communication to connect the hearing device (102) to a user's device; and
an outer groove part formed around the peripheral of the hearing device (102) that enables the hearing device (102) to be fitted into the device enclosing part (302).

25. The method as claimed in claim 16, wherein the magnetic stimulator (912) is configured to generate a stimulatory electromagnetic field from modulated electrical signals from the controller (906) to provide a sensory audible stimulation, and wherein the magnetic stimulator (912) comprises a pair of resonant coils comprising magnetic cores around which current carrying wires are wound.

26. The method as claimed in claim 16, wherein the hearing device (102) comprises a head band (500) for attaching the hearing device (102), comprising:
an elongated band support (502) that surrounds and covers the behind part of the head when worn by the user;
a pair of device supporting sections (504/1) and (504/2) configured to be place behind the ear when worn by the user, so that the hearing device (102) can be placed behind the ear of the user and firmly supported on either of the head band (500); and
a pair of end sections (506/1) and (506/2) configured to sit in front of the ears when worn by the user to support the head band (500).

27. The method as claimed in claim 16, wherein the hearing device (102) comprises a ring featured structure (600) comprising:
a band connector (602) configured to connect to a device supporting section (504) of the head band (500), wherein the band connector (602) comprises adjustable connecting parts to enable connection of the ring featured structure (600) to the head band (500); and
a device holder (604) comprising a rigid material to firmly secure the hearing device (102).

28. The method as claimed in claim 16, wherein the head band (500) is connected to an assembly (800) of an assembled ring featured structure, configured to:
fix the assembled ring featured structure (600) to the head band (500); and
place the hearing device (102) behind the user's ear so that the female mating member (104) of the hearing device (102) is connected with the male mating member (108) of the adhesive member (106) which is attached behind the ear.

29. The method as claimed in claim 16, wherein the hearing device (102) comprises a button or switch to enable the user to change between two hearing modes of the hearing device (102), wherein the two hearing modes comprise a hearing mode and a regular mode.

30. The method as claimed in claim 29, wherein the hearing aid mode is configured to enable using the hearing device (102) as hearing aid device, comprises the microphone (902) captures ambient audio signals from a surrounding environment;

31. The method as claimed in claim 29, wherein the regular mode is configured to enable using the hearing device (102) as an ear phone comprises the wireless transceiver (916) and the audio processor (904) to receive audio signals from an external device connected to the hearing device (102).
